(19) United States
(12) Patent Application Publication
(10) Pub. No.: US 2023/0044043 A1
(43) Pub. Date: Feb. 9, 2023

(54) METHOD AND SYSTEM FOR AUTOMATED GRADING AND TRADING OF NUMISMATICS AND TRADING CARDS

(71) Applicant: Coin and Card Auctions, Inc., Oroville, CA (US)

(72) Inventor: Mike Johnson, Oroville, CA (US)

(73) Assignee: Coin and Card Auctions, Inc., Oroville, CA (US)

(21) Appl. No.: 17/818,149

(22) Filed: Aug. 8, 2022

Related U.S. Application Data
(60) Provisional application No. 63/230,727, filed on Aug. 7, 2021.

(51) Int. Cl. G06T 7/00

(52) U.S. Cl. CPC G06T 7/0002; G06T 2207/20084; G06T 2207/10024; G06Q 30/0278

(57) ABSTRACT

A method, system and platform for implementing an automated grading system that can reliably and efficiently grade a trading object such as numismatics and trading cards are disclosed. Via adopting industry-standard grading scales, the present computer-assisted numismatics and sports trading card platform utilizes various techniques, such as laser scanning, machine vision, smartphone IOS and Android native installed object recognition, neural network models, blockchain, NFT with smart contracts, digital fingerprints identified as intellectual property and royalties to enable consistent grading and trading of a large quantity of trading objects. It can further enable authenticity verification, and transactions of the graded trading objects.

### CROSS-REFERENCES TO RELATED APPLICATIONS

This application claims the benefit of U.S. Provisional Patent Application No. 63/230,727, entitled “METHOD AND SYSTEM FOR AUTOMATED GRADING AND TRADING OF NUMISMATICS AND TRADING CARDS,” filed Aug. 7, 2021, which is incorporated herein by reference for all purposes.

### TECHNICAL FIELD

The present subject matter is in the field of computer-aided grading and trading of numismatics and trading cards.

### SUMMARY OF THE INVENTION

Traditionally, there are multiple problems in the present numismatic and trading cards industry. First, consumers now pay marketplace platforms 10.5%-18+% to use platforms such as eBay, heritage auctions, etc. The high marketplace costs leave extraordinarily little consumer profit margin to reinvest into the market and stifle growth in the numismatics industry. Second, the present methodology for determining population, grade and price guides is antiquated and fails to include certain critical metrics. For example, the present marketing platforms include enterprise systems that use keyword-based and other search algorithms that fail to aggregate and centralize data results and grading systems are based on antiquated technical and market grading processes which fail to utilize nano level laser, machine vision systems and smartphone IOS/Android data and artificial intelligence to process and compile outputs measured height, color and images data based exclusively on science and technologies. While this was previously efficient, today's technologies have changed marketing and grading metrics and offered new opportunities for security and efficiency.

The present subject matter pertains to a novel approach for automatic, computer-aided grading and trading of numismatics, bullion and trading cards via various hardware and software components. The method and system can provide an instantaneous and accurate grading of a trading object, e.g., a coin or a sport trading card, using one or more international industry grading standards, e.g., ANA, PCGS, NGC, Sheldon Grading Scale (numismatics) and Beckett, PSA Grading Scale (sports trading cards). In addition to a grading score, a detailed grading report, such as a digital fingerprint, can be generated to visualize the grading factors. The method and system further utilize various technologies such as neural network models, NFT (Non-fungible token) and NFT marketplaces, metaverse and blockchain technologies, smart contracts, digital wallets, royalties, cryptocurrencies, processes and exchanges for implementing commerce of the present subject matter.

To generate a reference database, the system can receive image data comprising height, color, pixelation and reflective measurements data of a number of reference objects with known grading scores, e.g., ANA, NGC, PCGS, Sheldon Grading Scale and Beckett, PSA Grading Scale. Such image data can comprise, for example, laser scanning 2D and 3D images, height, and color measured outputs machine vision 2D and 3D images and height and color measured outputs and mobile computing device images and data. Via computer vision techniques, the system can correlate the image data with the known grading systems to generate a reference database.

According to some embodiments, a neural network model such as a deep neural network (DNN) or a convolutional neural network (CNN) can be trained with pre-processed datasets, e.g., feature vectors, based on the image, height and color data of the reference objects and the known grading systems. Other artificial intelligence or machine learning models that can provide a framework to automate the grading process of a trading object can also be adopted. The trained model can be used to predict a grading score of an ungraded trading object using, for example, the object's images taken by a mobile computing device.

Furthermore, the present subject matter can automatically provide a price estimation of the trading object at least based on the determined grade. Other factors, such as the estimated population or existing number of the trading object, the previous sales price of a similar trading object, can also be used to provide the price estimation. In addition, the present subject matter can enable online transactions or sales of a trading object. The present subject matter can also provide data validation pre- and post-sale for the transaction of the trading object.

In addition, the system can confirm the authenticity of the ungraded trading object by verifying the received image data with the authentic reference objects, or by another neural network model that has been trained with the requisite datasets.

A computer implementation of the present subject matter comprises: scanning a plurality of reference objects, generating a plurality of reference images and height and color data correlating the reference images, height and color data to a standard grading system, generating a reference database based on the correlated reference images, receiving one or more images of a trading object, and determining a grading score of the trading object based on the one or more images and the reference database.

According to some embodiments, the correlated reference images comprise height, color and pixelation measures of the trading object. The generating a plurality of reference images and correlating the reference images to a standard grading system further comprises generating a plurality of reference height and color data and correlating the reference height and color data to a standard grading system.

According to some embodiments, the trading object can be a coin, a sport trading card, a comic book, or any predetermined trading object that is suitable for the present subject matter. According to some embodiments, the received reference images can comprise, for example, laser scanning images, machine vision images and mobile computing device images.

According to some embodiments, in addition to a grading score, the system can further generate a grading report and digital fingerprint that can provides more grading details. For example, a grading chart can compare the present trading object with a standard reference object so that the differences or similarities between the two can be visualized in a quantitative approach. In addition, other grading factors, such as the evaluated measurements, can be provided in the grading report and digital fingerprint.

According to some embodiments, the standard grading system of the present subject matter can comprise any industry-standard grading system for a trading object, such as numismatic grading scales ANA/NGC/PCGS/Sheldon Grading Scale and Beckett and PSA sports card Grading Scales.

According to some embodiments, the system can adopt a DNN model with multiple input and output layers for determine the grading score of an ungraded trading object. The DNN model can be trained with pre-processed datasets, such as extracted feature vectors, based on correlated references images, height and color data (input) and known grading scores (output).

According to some embodiments, the system can determine an appraisal price or market price of the trading object based on a number of factors, such as the assigned grading score, a population report of the trading object based on one or more databases and sales data of at least one similar trading object.

The present subject matter addresses long-lasting problems in the present numismatic and trading cards industry through implementing multiple technologies. One solution is using the internationally utilized third-party ANA/PCGS/NGC and 70-point Sheldon Grading Scale grading systems and Beckett or PSA 10 point Sports Trading Card Grading system. Topography scans at the nano level or consistently produce repeatable measurements of topographies which are compared with not less than 20 range parameters defined by 3D nano level scans of existing professionally graded encapsulated numismatics and sports trading cards. Multiple technologies are utilized, including:
1. Nano level 3D topography scan
2. Nano level machine vision topography imaging, height, color, data and smartphone images
3. Densitometer optical density measurement (absence of light).
4. Spectrophotometer wavelength color in nanometer increments for spectral curve.

While the hardware and software technologies for outputs exists, there is no output conversion into ANA/PCGS/NGC/Sheldon, Beckett or PSA Grading Scales equivalents. The present solution include data output, correlation and conversions to both the ANA/NGC/PCGS/ANACS/Sheldon and Beckett/PSA Grading Scale equivalents.

This solves grading consistency problems experienced today industrywide with outputs compared by computer software analysis against known encapsulated numismatic “masters” from PCGS and NGC in every grade range converted to the ANA/PCGS/NGC/70-point Sheldon Grading Scale (Numismatics) and the known encapsulated PSA and Beckett graded sports trading cards using the 10-point PSA and Beckett Grading Scale (Sports Trading Cards). Nano level imaging and measurement outputs alone are not the only applied science and technology as optical density measurements and nanometer incremental color measurements under controlled conditions completed by experts are matched against ranges of known color designations as assigned to masters graded by ANA, PCGS, NGC and Beckett and PSA. Each master is kept in its encapsulated and graded form for analysis and range assignments to the respective ANA/PCGS/NGC/Sheldon or Beckett or PSA grade equivalents.

Good practices within the numismatics and sports trading card grading industries are imperative and necessary to ensure consumer confidence and serve to normalize established internationally accepted ANA/PCGS/NGC and Sheldon Grading and Beckett and PSA Grading systems. The computer assisted comparisons to eliminate physical eye strain and varied levels of knowledge, skills and abilities industrywide and this technology applies equally to foreign numismatics and sports trading cards. To scale volume for commercial use we are developing a computer-assisted automated numismatics and sports trading card grading platform with runtime environment DNN and artificial intelligence processing and embedded software applications and smartphone IOS and ANDROID applications in conjunction with multiple MySQL databases and networked domains networked in a using blockchain technologies, NFT, Smart contracts, royalties, crypto currency, digital wallets and crypto currency exchanges and established protocols, processes and procedures adopted for metaverse and NFT marketplaces for commerce and those utilized in conventional non NFT and non-metaverse marketplaces for commerce.

Underlying MySQL databases and AWS provides data storage and data query capacities enabling defined table and field extractions of compiled data for grading and market analysis, including pricing metrics and smartphone IOS and Android application originated query based graphic user interface including pre- and post-sale trading object validation Small scale 500 registered storefronts and unlimited non storefront auctions participants provide funneled marketing avenues maximizing users' sales.

Software applications are multipurpose designed for use in MySQL databases situated on a Deep Neural Network/AI runtime engine using blockchain technologies/smart contracts/royalties/NFT/cryptocurrency and cryptocurrency exchanges and front-end mobile smartphone platforms. Applications use digital fingerprints, intellectual property, digital wallets, smart contracts/royalties/cryptocurrencies, cryptocurrency exchanges, NFT marketplace and metaverse for commerce and non-fungible tokens for converted data, including digital and pixelated imagery, and hash with a unique identification.

Mobile smartphone applications capture images as 10-12-pixel image topography and as pixilated imagery with the assignment of unique identifiers. Data transmits (uploads) to the server and database. Data queries from smartphone applications enable pre point of sale and point of purchase asset and transaction validation and authentications of non-encapsulated numismatics and non-encapsulated sports trading cards, including digital fingerprints and reports and downloadable certification of grade and valuation metrics and data with user capability to uploading data for marketing and sales onto the database(s) and web-based marketplace application. This technology removes the need to send in numismatics to a third-party grading company and allows sales to occur with downloadable certification and digital fingerprints backed by science and technologies. Users may request and receive encapsulation for a fee after a determination of value and grade by use of the smartphone applications.

The computer-assisted automated numismatics and sports trading card platform enable market penetration to existing third-party grading companies for shared and non shared royalties and fees. COGS due to automation is expected to reduce operating overheads by at least 30%.

### DESCRIPTION OF DRAWINGS

The patent or application file contains at least one drawing executed in color. Copies of this patent or patent application publication with color drawing(s) will be provided by the Office upon request and payment of the necessary fee.

The present subject matter is illustrated by way of example, and not by way of limitation, in the figures of the accompanying drawings in which:

FIG. 1 shows an exemplary diagram of an automated grading system, according to one or more embodiments of the present subject matter;

FIG. 2 shows exemplary data sources for an automated grading system, according to one or more embodiments of the present subject matter;

FIG. 3A shows exemplary image data from a 3-D laser scanner, according to one or more embodiments of the present subject matter;

FIG. 3B shows an exemplary grading chart, according to one or more embodiments of the present subject matter;

FIG. 4 shows more exemplary image data from a 3-D laser scanner, according to one or more embodiments of the present subject matter;

FIG. 5 shows some exemplary processes for computer-aided grading of a trading object, according to one or more embodiments of the present subject matter;

FIG. 6 shows some exemplary processes for computer-aided grading of a trading object, according to one or more embodiments of the present subject matter;

FIG. 7A shows a server system of rack-mounted blades, according to one or more embodiments of the present subject matter;

FIG. 7B shows a diagram of a networked data center server, according to one or more embodiments of the present subject matter;

FIG. 8A shows a packaged system-on-chip device, according to one or more embodiments of the present subject matter; and

FIG. 8B shows a block diagram of a system-on-chip, according to one or more embodiments of the present subject matter.

### DETAILED DESCRIPTION

In the following description, for purposes of explanation, numerous specific details are set forth in order to provide a thorough understanding of the present subject matter. It will be apparent, however, to one skilled in the art that the present subject matter may be practiced without some of these specific details. In addition, the following description provides examples, and the accompanying drawings show various examples for the purposes of illustration. Moreover, these examples should not be construed in a limiting sense as they are merely intended to provide examples of embodiments of the subject matter rather than to provide an exhaustive list of all possible implementations. In other instances, well-known structures and devices are shown in block diagram form in order to avoid obscuring the details of the disclosed features of various described embodiments.

The present subject matter pertains to improved approaches to an automated computer-assisted numismatics and sports trading card platform and system by adopting industry-standard grading scales, the present computer-assisted numismatics and sports trading card platform utilizes various techniques, such as laser and machine vision object recognition, neural network models, blockchain, NFT with smart contract to enable consistent grading of a large quantity of trading objects. It can further enable authenticity verification and transactions of the graded trading objects via at least one of a conventional marketplace or a NFT/Metaverse auction or a storefront platform.

A method and system for implementing an automated, repeatable grading system that uses internationally accepted ANA, NGC, PCGS, Sheldon and Beckett and PSA Grading Scales are disclosed. The system comprises an automated computer-assisted Numismatics and Sports Trading Card platform using machine vision systems and other referenced technologies capable of consistently grading thousands of coins and sports trading cards per day, which will stabilize and promote growth within the industries referenced. The utilization of Smartphone IOS and Android, Blockchain technologies and NFT with smart contract, digital fingerprints, intellectual property and royalties targets encapsulated and raw coins or ungraded coins and ungraded sports trading cards, which can potentially enable millions of users/buyers/sellers with instant ability to determine identity, grade and value their objects. It further enables them to list, sell, authenticate the object and transaction preceding and post-sale and purchase the objects from a smartphone application.

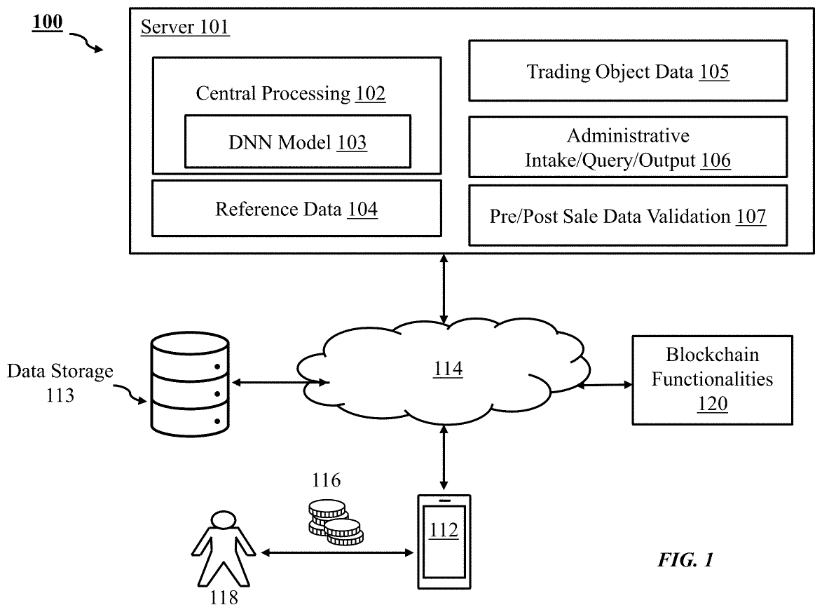

FIG. 1 shows an exemplary diagram of an automated grading system 100 for automated grading of a trading object. According to some embodiments, the automated grading system 100 can comprise a server 101 configured to implement multiple functions of the system, a data storage 113 such as a cloud data storage, a mobile computing device 112 such as a smart phone or a personal computing device, and a network 114.

Server 101 can comprise a number of modules or units to implement functions of the present subject matter. According to some embodiments, server 101 can implement functions related to central processing 102, DNN model 103, reference data 104, trading object data 105, administrative intake, query and output 106, and pre/post sale data validation 107. Other relevant functions, such as DNN model training and data processing, can also be implemented by campaign management server 101.

Network 114 can comprise a single network or a combination of multiple networks, such as the Internet or intranets, wireless cellular networks, local area network (LAN), wide area network (WAN), WiFi, Bluetooth, near-field communication (NFC), etc. Network 114 can comprise a mixture of private and public networks or one or more local area networks (LANs) and wide-area networks (WANs) that may be implemented by various technologies and standards.

Mobile computing device 112 can be a personal, portable computing device that has at least one microphone for receiving voice commands and at least one network interface for wireless connection. Examples of mobile computing device 112 include a personal digital assistant, a mobile or a smartphone, a wearable device such as a smartwatch, a smart glass, a tablet computer, or an automobile. Mobile computing device 112 can have at least one microphone, and at least one camera as I/O (input/output) devices. Mobile computing device 112 can have at least one network interface configured to connect to network 114.

According to some embodiments, automated grading system 100 can receive a number of reference objects with known grading scores. Reference data 104, including reference images or data sources, can be generated based on these reference objects via various imaging techniques, such as laser scanning, machine vision and mobile computing device images. For example, a data source can comprise measured height and color, images and pixelation data and images captured by a laser scanner, machine vision system and smartphone IOS and Android device for 500 coins of the same basic type, e.g., all Wheat cents.

According to some embodiments, the system can generate a reference database based on the image data and the corresponding grading scores and save it in data storage 113. Various object recognition techniques can be adopted for feature extraction and processing of the data sources. For example, the system can use an object-based approach to classify the segments of the reference images, wherein each segment comprises a group of pixels with similar spectral, spatial, and/or texture attributes. The reference database can comprise, for example, extracted features or characteristics of the reference images. According to some embodiments, the reference database can receive a grading query with image data of an ungraded trading object, and output its estimated grading score.

According to some embodiments, the system can train a DNN model 103 to predict or assign a grading score for the ungraded trading object. For example, the system can train the DNN model with pre-processed dataset, e.g., extracted feature vectors, based on the multiple data sources. Other artificial intelligence or machine learning models that can provide a framework to automate the grading process of a trading object can also be adopted. According to some embodiments, attributes learning/assignments as +/− values to base grades can be deployed to provide a framework to automate the grading process of a trading object.

According to some embodiments, a user 118 can use one or more cameras of mobile computing device 112 to snap images of a trading object 116, such as a coin, to generate trading object data 105. Through executing administrative intake 106, a grading application executing on the mobile computing device 112 can transmit trading object data 105 to server 101 via network 114. Next, the system can execute administrative query 106 to generate an output for the estimated grading score of trading object 116 via, for example, a trained DNN model 103.

According to some embodiments, in addition to the predicted grading score, server 101 can automatically provide a price estimation of the trading object at least based on the determined grade. Other factors, such as the estimated population or existing number of the trading object, the previous sales price of a similar trading object, can also be used to provide the price estimation. In addition, the present subject matter can enable online transactions or sales of a trading object. The present subject matter can also provide data validation for the transaction of the trading object.

In addition, server 101 can determine the authenticity of the ungraded trading object by verifying trading object data 105 with the authentic reference objects, or by another neural network model that has been trained with the requisite datasets.

According to some embodiments, the system can implement additional blockchain functionalities 120 related to the evaluation, trading and transactions of the trading object. Example of blockchain functionalities 120 can comprise NFT minting and applications, NFT marketplaces, crypto currency exchanges, smart contracts, royalties, Metaverse for commerce.

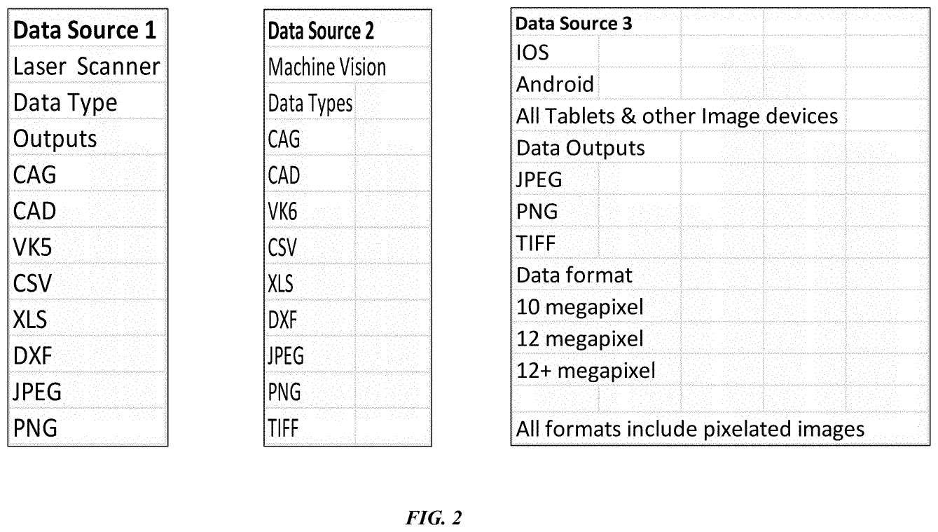

In addition, according to some embodiments, the system can adopt a DNN model with AI runtime engine for data and image processing including prediction, classification and clustering to identify candidate model architectures, relative levels of model performance and the relative influences of feature vector elements, all of which are designed for decompile, re-implement and reliably assign grading scores pursuant to multiple industry standard grading scales. Furthermore, the DNN model can enable prototype applications developed for IOS/Android applications on mobile devices. These applications can adopt native use of megapixel cameras and GUI functionalities for conventional markets or emerging markets such as NFTs, smart contracts, royalties, Blockchain, NFT marketplaces and metaverse, crypto currencies and crypto currency exchanges for commerce purpose. FIG. 2 shows three exemplary data sources for the grading system, including data source 1 by laser scanning, data source 2 by machine visioning, and data source 3 by mobile device imaging.

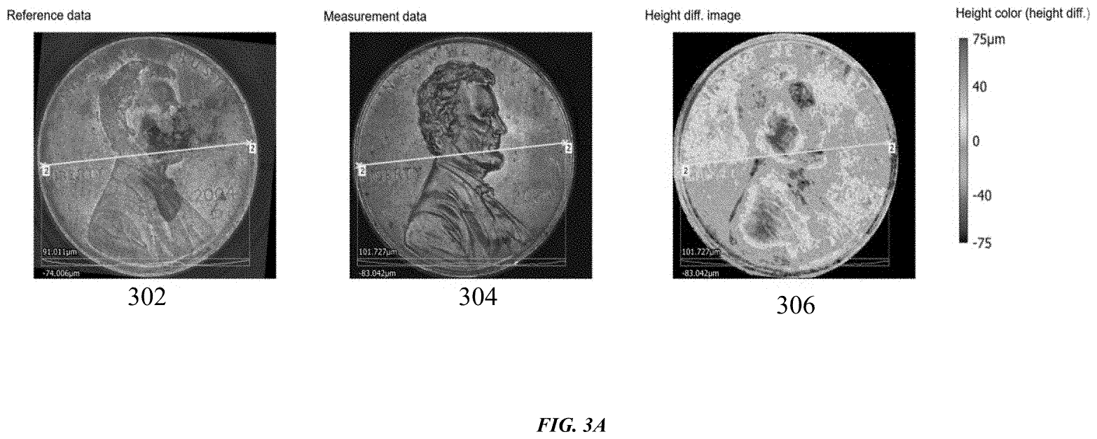

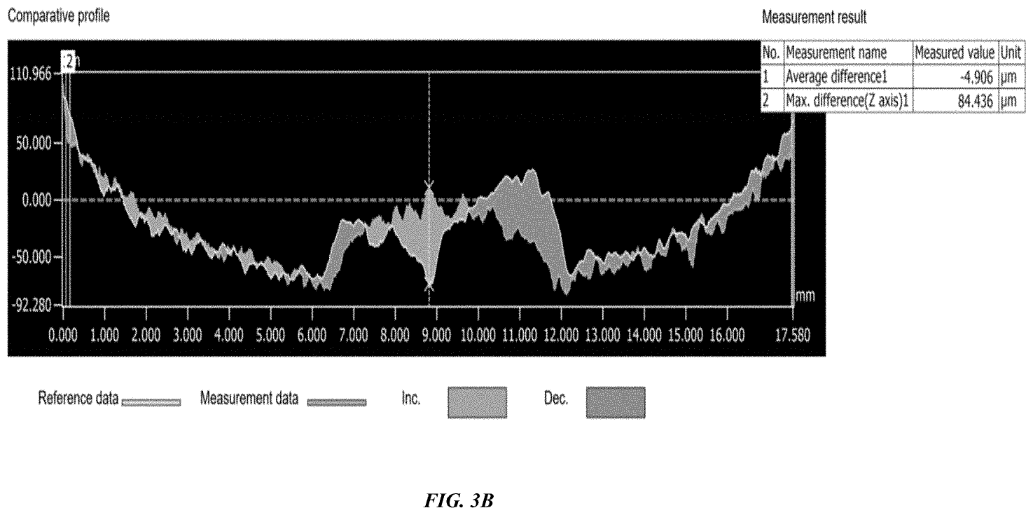

FIG. 3A shows exemplary image data from a 3-D laser scanner. FIG. 3A shows exemplary comparative measurements of a penny captured by a 3-D laser scanner, e.g., an Keyence VK-X3000 Series scanner. It comprises reference data 302 of penny 1, measurement data 304, and the 3-D scanned imaging data 306.

FIG. 3B shows an exemplary grading chart of penny 1 against a standard penny with known grading score. As shown in FIG. 3B, the grading chart can show the differences or similarities between the two pennies, thus indicating the underlying grading factors for the predicted grading score.

According to some embodiments, the system can further generate a digital fingerprint and grading report that can provides more grading details. In addition to the digital fingerprint and grading report other grading factors, such as the evaluated measurements, can be provided in the digital fingerprint and in the grading report.

According to some embodiments, the system can determine an appraisal price of the trading object based on a number of factors, such as the assigned grading score, a population report of the trading object based on one or more databases and sales data of at least one similar trading object. All these data can be retrieved from one or more databases associated with the system.

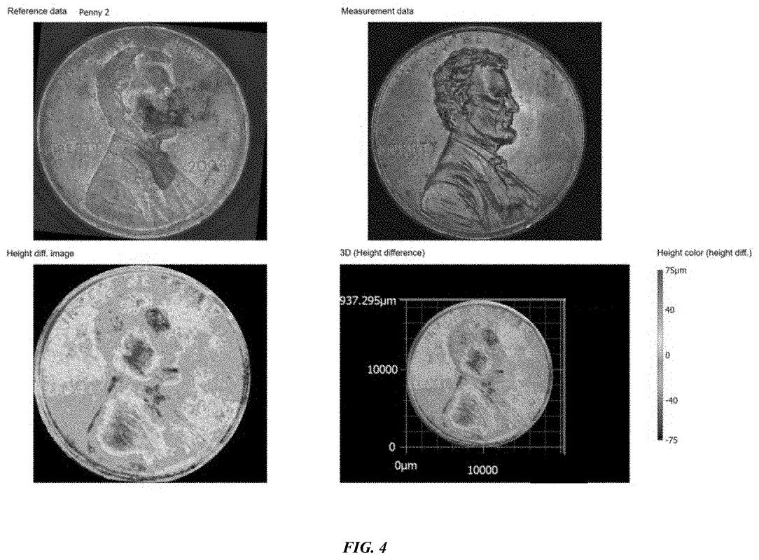

FIG. 4 shows more exemplary image data from a 3-D laser scanner that comprises exemplary image data of a penny.

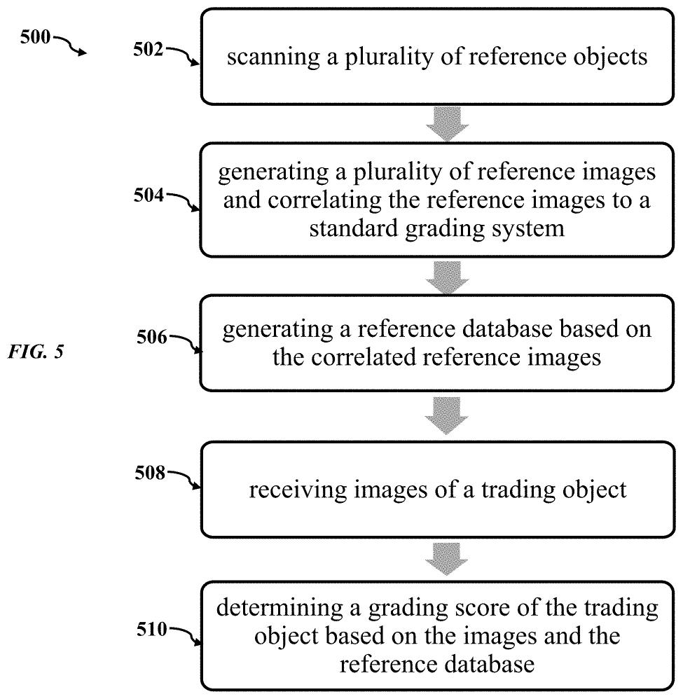

FIG. 5 shows some exemplary processes 500 for computer-aided grading of a trading object. At step 502, the system can scan a plurality of reference objects with known grading scores via various imaging techniques. At step 504, the system can correlate the generated reference images with the known grading scores based on an industry-standard grading system for a trading object, such as a ANA/PCGS/NGC, Sheldon Grading Scale, Beckett and a PSA Grading Scale.

At step 506, the system can generate a reference database based on the correlated reference images. To compile the reference database, various object recognition techniques can be adopted for feature extraction and processing of the data sources. For example, the system can use an object-based approach to classify the segments of the reference images, wherein each segment comprises a group of pixels with similar spectral, spatial, and/or texture attributes. The reference database can comprise, for example, extracted features or characteristics of the reference images.

According to some embodiments, a neural network model, e.g., a DNN model, can be trained with pre-processed datasets, e.g., feature vectors, based on the image data of the reference objects (input) and the known grading scores (output).

At step 508, the system can receive images of a trading object. For example, the trading object's image taken by a mobile computing device. At step 510, the system can determine a grading score of the trading object by query the established database. According to some embodiments, the trained model can be used to predict the grading score of the ungraded trading object.

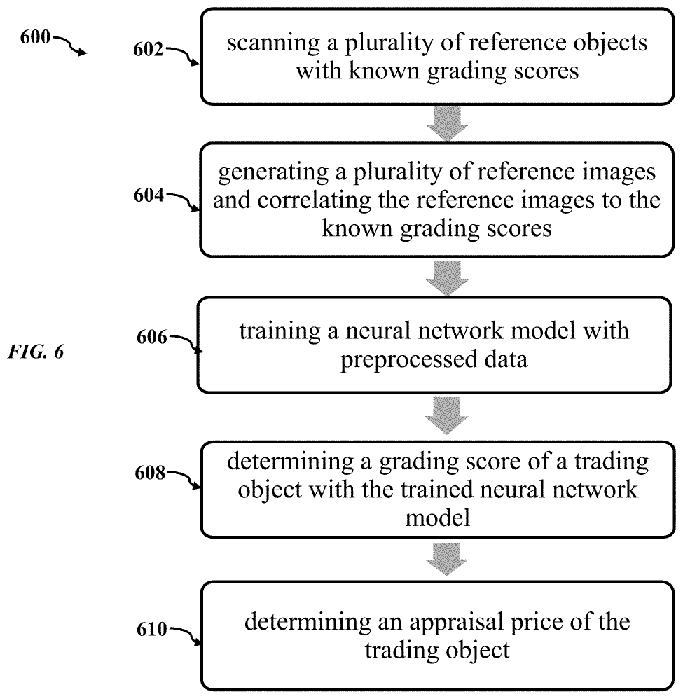

FIG. 6 shows some exemplary processes 600 for computer-aided grading of a trading object. At step 602, the system can scan a plurality of reference objects with known grading scores via various imaging techniques. At step 604, the system can correlate the generated reference images with the known grading scores based on an industry-standard grading system for a trading object.

At step 606, the system can train a DNN model with pre-processed datasets, e.g., feature vectors, based on the image data of the reference objects (input) and the known grading scores (output). At step 608, the system can receive mobile phone images of a trading object and determine a grading score of a trading object with the trained DNN model.

At step 610, the system can further determine an appraisal price of the trading object based on a number of factors. For example, in addition to the assigned grading score, the system can generate or retrieve a population report of the trading object in a target market; the system can query one or more databases to obtain sales data of at least one similar trading object. All these factors can be used to determine the appraisal price. In addition, a neural network model can be trained with relevant sales data to predict the likely price of a trading object.

According to some embodiments, the system can determine the authenticity of the ungraded trading object by verifying the received image data with the authentic reference objects, or by another neural network model that has been trained with the requisite datasets.

According to some embodiments, the present method and system can decompile, re-implement and reliably assign grading scores in accordance with the following exemplary industry standards.

Coin Grading—The 1-70 Point Sheldon Coin Grading Scale

Numismatic coins are graded by the three leading third-party grading services: PCGS, NGC and ANACS. Each service will grade a coin between 1 and 70 based on the Sheldon Scale, developed by Dr. William Sheldon in 1949. It is the standard for the rare coin industry.

Sheldon Scale for Grading U.S. Coins

Poor-1 or P-1 (Poor)

Fair-2 or FR-2 (Fair)

AG-3 (About Good)

G-4 (Good)

G-6 (Good-plus)

VG-8 (Very Good)

F-12 (Fine)

VF-20 (Very Fine)

VF-30 (Good Very Fine)

EF-40 (Extremely Fine)

XF-45 (Choice Extremely Fine)

AU-50 (About Uncirculated)

AU-55 (Good About Uncirculated)

AU-58 (Choice About Uncirculated)

MS-60-MS-70 (Mint State)

Large value differences between even one grading level are common and particularly on condition rarities. Mint State in particular can jump between MS-63 and MS-64 and MS-65, depending on the coin issue.

Proofs—Proofs are a type of coins, and generally fall into the Proof-60-Proof-70 numerical grading, since most proofs have not been circulated.

In addition to grading numerically, attributes present are added for certified coins, including PL for Proof Like, DMPL/DPL for Deep Mirror Proof Like, DCAM/UC for Deep Cameo/Ultra Cameo as well as certain color attributes such as used in Lincoln Cents including Brown, Red Brown and Red. There are numerous additional attributes not referenced but are part of the overall grade and valuation metrics. Applied technologies capture and define all attributes and are assigned accordingly.

VAR—Range Variable Assigned to Respective Grade(s)

Nano level topography measurement outputs calibrated with existing PCGS, NGC encapsulated, and graded numismatics and Nano level outputs calibrated to PSA and Beckett graded and encapsulated sports trading cards with a minimum of 20 scan outputs per each grade within each respective system to ensure repeatability and grade accuracy. Scan outputs start at the highest possible encapsulated graded numismatics and/or encapsulated sports trading cards and ranges are established by comparative analysis of outputs from identified master samples. All master samples at each successive grade level are preserved and stored in a bank vault under the control of Coin and Card Auctions, Inc., as reference materials.

Card Grading—The PSA Grading Scale

Sports and trading cards, i.e., any collectible cards, are typically graded based on the PSA Grading Scale, which is developed by Professional Sports Authenticator (PSA). The following is an exemplary PSA grading scale that can be referenced to and incorporated into the present subject matter.

Psa Grading Scale

GEM-MT 10 (Gem Mint):

A PSA GEM-MT 10 is a virtually perfect card, from its four sharp corners and no creasing to its sharp focus and full original gloss intact. A card that earns this distinction must be free of any staining, though allowances are made for slight printing imperfections if they don't impair the card's overall appeal. The image must be centered on the card within a tolerance not to exceed 55/45 to 60/40 percent on the front and 75/25 percent on the reverse.

MINT 9 (Mint):

A PSA MINT 9 is a superb condition card that exhibits only one of the following minor flaws: a very slight wax stain on the reverse, a minor printing imperfection or slightly off-white borders. Centering must be approximately 60/40 to 65/35 or better on the front and 90/10 or better on the reverse.

NM-MT 8 (Near Mint-Mint):

A PSA NM-MT 8 is a super high-end card that appears Mint 9 at first glance, but upon closer inspection can exhibit one or more of the following: a very slight wax stain on the reverse, slightest fraying at one or two corners, a minor printing imperfection and/or slightly off-white borders. Centering must be approximately 65/35 or 70/30 or better on the front and 90/10 or better on the reverse.

NM 7 (Near Mint):

A PSA NM 7 is a card showing slight surface wear visible only upon close inspection. There may be slight fraying on some corners. Picture focus may be slightly out-of-register although a minor printing blemish is acceptable. Slight wax staining is acceptable on the back of the card only. Most of the original gloss is retained. Centering must be approximately 70/30 to 75/25 or better on the front and 90/10 or better on the reverse.

EX-MT 6 (Excellent-Mint):

A PSA EX-MT 6 card may have visible surface wear or a printing defect which does not detract from its overall appeal. A very slight scratch may be detected only upon close inspection. Corners may have slightly graduated fraying and picture focus may be slightly out-of-register. Card may show some loss of its original gloss, may have minor wax stain on reverse, may exhibit very slight notching on edges and may also show some off-whiteness on borders. Centering must be 80/20 or better on the front and 90/10 or better on the reverse.

EX 5 (Excellent):

On a PSA EX-5 card, minor rounding of the corners is becoming evident. Surface wear or printing defects are more visible. There may be minor chipping on edges. Loss of original gloss will also be more apparent. Focus of picture may be slightly out of register. Several light scratches may be visible upon close inspection but don't detract from the appeal of the card. Card may show some off-whiteness of borders. Centering must be 85/15 or better on the front and 90/10 or better on the back.

VG-EX 4 (Very Good-Excellent):

A PSA VG-EX 4 card's corners may be slightly rounded and surface wear is noticeable. The card may show light scuffing or scratches with some original gloss still intact. Borders may be slightly off-white and light creasing visible. Centering must be 85/15 or better on the front and 90/10 or better on the back.

VG 3 (Very Good):

A PSA VG 3 card reveals some rounding of the corners, although nothing extreme. Some surface wear is evident as well as light scuffing and/or scratches. The focus on the card may be somewhat off-register and much of the card's original gloss may be lost. Other elements that may lead to a grade of VG 3 include a slight stain may be showing on the obverse as well as wax staining on the reverse. Centering must be approximately 90/10 or better on the front and back.

GOOD 2 (Good):

A PSA Good 2 card's corners will show accelerated rounding and surface wear is obvious. There might also be several creases on the card as well as scratching, scuffing, light staining or even chipping on the obverse. As for the card's original gloss, it might be completely gone. The card may also show considerable discoloration. Centering must be approximately 90/10 or better on the front and back.

FR 1.5 (Fair):

A PSA Fair 1.5 card, denoting a half-grade, shows extreme wear possibly even affecting the framing of the picture. The surface of the card will no doubt show advanced signs of wear including scuffing, scratching, chipping, and staining. The picture on the card may possibly be out of register and its borders may have become brown and dirty. To receive a Fair grade, a card must be fully intact, which means no missing pieces whatsoever (major tear or missing corner, etc.). Centering must be 90/10 or better on the front and back.

PR 1 (Poor):

A PSA Poor 1 card will exhibit many of the same qualities of a PSA Fair 1.5 card although the defects may have advanced to such a serious stage that the card's eye appeal has completely vanished. A card with this designation may also be missing one or two small pieces (corners) and may exhibit major creasing. In addition, extreme discoloration or even dirtiness might make even it difficult to simply identify the issue.

### EXEMPLARY TERMS, CONCEPTS AND TECHNOLOGIES

The following terms, concepts and technologies can be utilized as examples to implement one or more embodiments of the present subject matter. However, various unlisted terms, concepts and technologies can be adopted. In addition, the following description, for purposes of explanation, used specific nomenclature to provide a thorough understanding of the embodiments of the invention. However, it will be apparent to one skilled in the art that the specific details are not required in order to practice the embodiments of the invention.

Conventional Marketplace and NFT Marketplace/Metaverse

MySQL Database

Domain name: Coin and Card Auctions, Inc (primary) and multiple subdomains/domains

Application structure CUSTOM—Auction Format 500 User Storefronts per database per each domain plus unlimited non storefront users plus unlimited store (non-auction format) dealers/licensed businesses and NFT/Metaverse Marketplace

Platform—Linux OS

Tech Stack, Website, CRM, —Primary DNS or Sub domain with integrations to HubSpot, Shopify, Google Ads, Facebook, Google Search Counsel, Google Analytics, Hotjar, JustUno, Zapier, PandaDoc, Stripe, DNN and AI runtime engine

3D Laser Scan topographies and pixilation imagery outputs conversions to ANA/NGC/PCGS and 70-point Sheldon Grading Scale and Beckett and 10-point PSA Grading Scale Equivalents.

Machine Vision Systems outputs interface and conversion to 3D Laser Scan equivalents of ANA/PCGS/NGC/Sheldon and Beckett and PSA Grading systems calculated as attributes with additional 10-12-pixel digital topography and pixilation imagery designed for NFT and smart contract over blockchain for pre and post database registration and validation at both pre and post listing, sale and purchase including data and images, estimated value, sales comparable, downloadable certification. chain and transfer of title.

UV-VIS spectrophotometer—Measure and compare outputs of Color measurements based on spectral reflectance with wavelength range from 380 nm to 780 nm equivalent to wavelengths sensed by the human eye standards of color as measurement converted within Sheldon and PSA grading numismatics and sports trading card grading guidelines to the respective attribute equivalent. Use of repeatable output precise nanometer color increments create spectral curve for unique identification used in conjunction with scan topographies. Spectral curve range of color identified as numismatics or sports trading card attribute equivalents assigned an attribute value as part of an overall final grade.

Gram Scale—used for weight analysis—compares known weight to actuals and converts to formulated range as component of grade attribute assignment

Glossmeter outputs measured as specular reflection gloss of coin(s) surfaces by projecting a beam of light at a fixed intensity and angle onto a surface and measuring the amount of reflected light at an equal but opposite angle. Gloss Range values based on 60° Value with High Gloss: >70 GU, Low Gloss: <10 GU, Medium Gloss: 10-70 GU converted to numismatics equivalents equal to PL, DMPL and other numismatics and or sports trading card grade equivalents as grade attributes.

X-Ray Fluorescence (XRF) technology converted to attribute values as a non-destructive analytical method used to determine elemental concentrations in various materials. Test used to determine gold, silver and/or alloys. Attributes assigned designed to detect counterfeits.

Magnet used in combination with XRF and 3D or Machine Vision and Digital scales to detect counterfeits. Each magnet output assigned an attribute value used in part to complete grading process.

Marketplace unique to numismatics and sports trading card industries. Set apart from competitors by smaller more versatile footprint configured with not more than 500 Storefront Users and unlimited non storefront and business owners. Configuration provides auction style venue to storefronts and non-storefronts at greatly reduced costs to consumer including a predetermined price monthly recurring for storefronts and a percentage of sales for non-storefronts. Storefronts enjoy a suite of value-added benefits including data mining producing comprehensive data accumulation across numerous websites at a single location, data scraping provides users the ability to bulk data capture existing user data on competitor websites with bulk posting and uploads to the Coin and Card Auction storefront without having to remove items from an existing venue. Custom marketing allows unique marketing options to storefront users with keyword specific paid marketing that funnels buyers or sellers directly to the storefront user's storefront. Storefronts can be sold by the storefront users and storefront values are similar in nature to a stand-alone business model valuation due to Coin and Card Auction proprietary marketing and management tools. The conventional and NFT/Metaverse marketplace is designed to operate on a blockchain and to assimilate, store and retrieve via query significant third-party grading data in accordance of the technologies applied as referenced above in this document.

Blockchain distributed layer technology—smart contract, royalties, and non-fungible tokens digitized data including but not limited to digitized topography, cryptocurrency and cryptocurrency exchanges and wallets, digital fingerprints and connective mechanisms and pixilated images and outputs.

Mobile applications include smartphone and other mobile devices containing a 10-12-megapixel camera or its equivalents. Users take images of raw or encapsulated coins and/or sports trading cards and (fee based) immediately retrieve identifying data from stored data contained in the database of the coin(s) and/or sports trading cards. Images taken by users are used to query stored data and compare images to Sheldon and or PSA Graded masters. Coins and or sports trading cards data is available for coin and/or sports trading card grade with downloadable certification. Smartcard and NFT technologies over blockchain provide a secure means to effect sale/transfer/purchase at point of sale and point of purchase along with chain of title and transfer of title. Both parties to any side of a transaction are able to validate the coin/sports trading card pre and post-sale independently of the other party simply by use of their own smartphone camera and a query against stored data on the databases.

Computer Assisted Numismatics Sports Trading Card Automated Grading Platform Technology developed is designed for a grading platform capable of grading for example, a minimum of 1,000 coins or sports trading cards per day. Each database while standalone is fully integrated and networked on a blockchain allowing consumers the ability to communicate freely worldwide. Blog, education, and open communications are designed to encourage user interaction and low pricing models are designed to increase user net operating income. The objective is to eventually move away from the auction format into a store format as the auction dynamics are self-destructive to growing the numismatics and sports trading card industries. Blockchain registered shared consumer/business royalties as a function of marketplace cost tied to intellectual properties unique to digital fingerprints creates a mechanism of perpetual royalties for commerce transaction on NFT/Metaverse for future generations to come. Each storefront offers its user the ability to embed a video to promote their business or products and each storefront has a unique custom-made individual graphic storefront design.

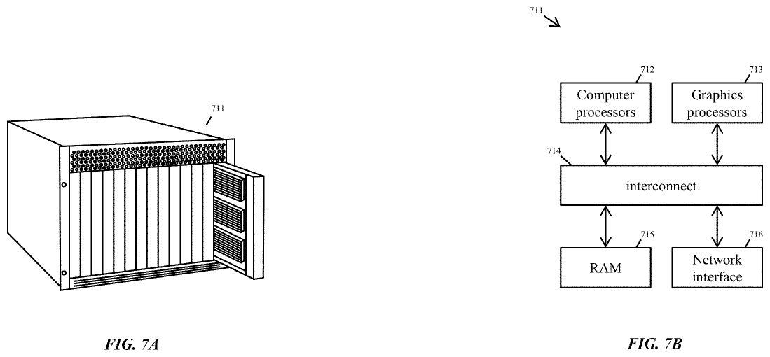

FIG. 7A shows a server system of rack-mounted blades for implementing the present subject matter. Various examples are implemented with cloud servers, such as ones implemented by data centers with rack-mounted server blades. FIG. 7A shows a rack-mounted server blade multi-processor server system 711. Server system 711 comprises a multiplicity of network-connected computer processors that run software in parallel.

FIG. 7B shows a diagram of a server system 711. It comprises a multicore cluster of computer processors (CPU) 712 and a multicore cluster of graphics processors (GPU) 713. The processors connect through a board-level interconnect 714 to random-access memory (RAM) devices 715 for program code and data storage. Server system 711 also comprises a network interface 716 to allow the processors to access the Internet, non-volatile storage, and input/output interfaces. By executing instructions stored in RAM devices 715, the CPUs 712 and GPUs 713 perform steps of methods described herein.

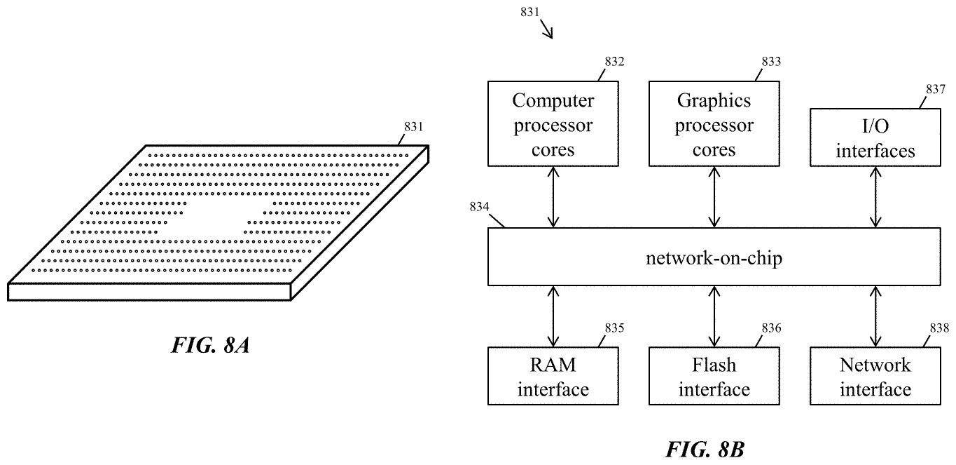

FIG. 8A shows the bottom side of a packaged system-on-chip device 831 with a ball grid array for surface-mount soldering to a printed circuit board. Various package shapes and sizes are possible for various chip implementations. System-on-chip (SoC) devices control many embedded systems, IoT device, mobile, portable, and wireless implementations.

FIG. 8B shows a block diagram of the system-on-chip 831. It comprises a multicore cluster of computer processor (CPU) cores 832 and a multicore cluster of graphics processor (GPU) cores 833. The processors connect through a network-on-chip 834 to an off-chip dynamic random access memory (DRAM) interface 835 for volatile program and data storage and a Flash interface 836 for non-volatile storage of computer program code in a Flash RAM non-transitory computer readable medium. SoC 831 also has a display interface for displaying a graphical user interface (GUI) and an I/O interface module 837 for connecting to various I/O interface devices, as needed for different peripheral devices. The I/O interface enables sensors such as touch screen sensors, geolocation receivers, microphones, speakers, Bluetooth peripherals, and USB devices, such as keyboards and mice, among others. SoC 831 also comprises a network interface 838 to allow the processors to access the Internet through wired or wireless connections such as WiFi, 3G, 4G long-term evolution (LTE), 5G, and other wireless interface standard radios as well as Ethernet connection hardware. By executing instructions stored in RAM devices through interface 835 or Flash devices through interface 836, the CPU cores 832 and GPU cores 833 perform functionality as described herein.

Examples shown and described use certain spoken languages. Various embodiments work, similarly, for other languages or combinations of languages. Examples shown and described use certain domains of knowledge and capabilities. Various systems work similarly for other domains or combinations of domains.

Some systems are screenless, such as an earpiece, which has no display screen. Some systems are stationary, such as a vending machine. Some systems are mobile, such as an automobile. Some systems are portable, such as a mobile phone. Some systems are for implanting in a human body. Some systems comprise manual interfaces such as keyboards or touchscreens.

Some systems function by running software on general-purpose programmable processors (CPUs) such as ones with ARM or x86 architectures. Some power-sensitive systems and some systems that require especially high performance, such as ones for neural network algorithms, use hardware optimizations. Some systems use dedicated hardware blocks burned into field-programmable gate arrays (FPGAs). Some systems use arrays of graphics processing units (GPUs). Some systems use application-specific-integrated circuits (ASICs) with customized logic to give higher performance.

Some physical machines described and claimed herein are programmable in many variables, combinations of which provide essentially an infinite variety of operating behaviors. Some systems herein are configured by software tools that offer many parameters, combinations of which support essentially an infinite variety of machine embodiments.

Several aspects of implementations and their applications are described. However, various implementations of the present subject matter provide numerous features including, complementing, supplementing, and/or replacing the features described above. In addition, the foregoing description, for purposes of explanation, used specific nomenclature to provide a thorough understanding of the embodiments of the invention. However, it will be apparent to one skilled in the art that the specific details are not required in order to practice the embodiments of the invention.

It is to be understood that even though numerous characteristics and advantages of various embodiments of the present invention have been set forth in the foregoing description, together with details of the structure and function of various embodiments of the invention, this disclosure is illustrative only. In some cases, certain subassemblies are only described in detail with one such embodiment. Nevertheless, it is recognized and intended that such subassemblies may be used in other embodiments of the invention. Practitioners skilled in the art will recognize many modifications and variations. Changes may be made in detail, especially matters of structure and management of parts within the principles of the embodiments of the present invention to the full extent indicated by the broad general meaning of the terms in which the appended claims are expressed.

Having disclosed exemplary embodiments and the best mode, modifications and variations may be made to the disclosed embodiments while remaining within the scope of the embodiments of the invention as defined by the following claims.

What is claimed is:

1. A computer-implemented method for automated grading of a trading object, comprising:
scanning a plurality of reference objects;
generating a plurality of reference images and correlating the reference images to a standard grading system;
generating a reference database based on the correlated reference images;
receiving one or more images of a trading object; and
determining a grading score of the trading object based on the one or more images and the reference database.

2. The computer-implemented method of claim 1, wherein the correlated reference images comprise height, color and pixelation measures of the trading object.

3. The computer-implemented method of claim 1, wherein the generating a plurality of reference images and correlating the reference images to a standard grading system further comprises generating a plurality of reference height and color data and correlating the reference height and color data to a standard grading system.

4. The computer-implemented method of claim 1, wherein the trading object is one of a coin, a sport trading card, or a predetermined trading object.

5. The computer-implemented method of claim 2, wherein the plurality of reference images comprises one or more of laser scanning images, machine vision images and mobile computing device images.

6. The computer-implemented method of claim 1, wherein the grading score is further associated with a grading chart and digital fingerprint to visualize grading factors.

7. The computer-implemented method of claim 1, wherein the standard grading system comprises one of a ANA/NGC/PCGS/Sheldon Grading Scale, a Beckett/PSA Grading Scale, or an industry-standard grading system.

8. The computer-implemented method of claim 1, wherein the one or more images of the trading object are captured by a mobile computing device.

9. A computer system, comprising:
at least one processor; and
memory including instructions that, when executed by the at least one processor, cause the computer system to:
scan a plurality of reference objects;
generate a plurality of reference images and correlate the reference images to a standard grading system;
generate a reference database based on the correlated reference images comprising height, color and pixelation measurement data;
receive one or more images of a trading object; and
determine, using a neural network model, a grading score of the trading object based on the one or more images and the reference database.

10. The computer system of claim 9, wherein the neural network model is a deep neural network (DNN) that has been trained with pre-processed datasets.

11. The computer system of claim 9, wherein the plurality of reference images comprises one or more of laser scanning images, machine vision images and mobile computing device images.

12. The computer system of claim 9, wherein the grading score is further associated with a grading chart and digital fingerprint to visualize grading factors.

13. The computer system of claim 9, further comprising instructions that, when executed by the at least one processor, cause the computer system to:
enable a transaction of the trading object via at least one of a conventional marketplace or a NFT/Metaverse auction or a storefront platform.

14. The computer system of claim 13, further comprising instructions that, when executed by the at least one processor, cause the computer system to:
provide data validation for the transaction of the trading object.

15. The computer system of claim 9 further comprising instructions that, when executed by the at least one processor, cause the computer system to:
generate a population report of the trading object based on one or more databases.

16. The computer system of claim 15, further comprising instructions that, when executed by the at least one processor, cause the computer system to:
retrieve sales data of at least one similar trading object.

17. The computer system of claim 16, further comprising instructions that, when executed by the at least one processor, cause the computer system to:
determine an appraisal price of the trading object at least based on the grading score, the population report and the sales data.

18. A computer-implemented method for automated grading of a trading object, comprising:
capturing, via at least one camera of a mobile device, one or more images of a trading object;
transmitting the one or more images of the trading object to a server; and
receiving a grading score of the trading object from the server, wherein the server is configured to:
scanning a plurality of reference objects;
generating a plurality of reference images comprising height, color and pixelation measurement data and correlating the reference images to a standard grading system;
generating a reference database based on the correlated reference images; and
determining the grading score of the trading object.

19. The computer-implemented method of claim 18, wherein the grading score is determined by a neural network model that has been trained with pre-processed datasets.

20. The computer-implemented method of claim 18, further comprising:
determining an appraisal price of the trading object at least based on the grading score, digital fingerprint, a population report of the trading object based on one or more databases and sales data of at least one similar trading object.
